(19) United States
(12) Patent Application Publication
(10) Pub. No.: US 2026/0260145 A1
(43) Pub. Date: Sep. 3, 2026

(54) TECHNIQUES FOR BASEBAND PULSE QUBIT CONTROL AND RELATED SYSTEMS AND METHODS

(71) Applicant: Atlantic Quantum Corp., Cambridge, MA (US)

(72) Inventors: Youngkyu Sung, Cambridge, MA (US); Christopher Ayala, Cambridge, MA (US); Bharath Kannan, Cambridge, MA (US); Sergey Novikov, Cambridge, MA (US)

(73) Assignee: Atlantic Quantum Corp., Cambridge, MA (US)

(21) Appl. No.: 19/006,659

(22) Filed: Dec. 31, 2024

(51) Int. Cl. G06N 10/40

(52) U.S. Cl. CPC G06N 10/40

(57) ABSTRACT

Techniques are described for controlling qubits using baseband pulse sequences. Many, or even all, qubits in a system can be controlled by baseband pulse sequences that are synchronized to a clock signal shared by the qubits. The baseband pulse control techniques allow many qubits to be driven with the same parameterized baseband pulse sequence applied based on a common clock signal, with parameters of the baseband pulse sequence selected based on the desired operation. This approach greatly simplifies the electronics needed to drive a collection of qubits, as there is no need for picosecond timing, nor the complexities that arise from varied gate durations.

### BACKGROUND

Quantum computing platforms promise to provide solutions to many computationally intractable problems. In a quantum computing platform, information is stored in quantum bits or “qubits,” and the power of the platform generally increases with the number of qubits that can be independently and simultaneously controlled. In quantum computing platforms comprising qubits such as trapped ions or neutral atoms, directed electromagnetic waves (e.g., microwaves, optical beams) implement independent qubit manipulations, while platforms comprising qubits such as electron dots or superconducting circuits use guided RF or microwave beams.

### SUMMARY

According to some aspects, the techniques described herein relate to a system including: a plurality of qubits including a first qubit and a second qubit; and at least one controller configured to: generate a common clock signal; apply a first baseband pulse sequence to the first qubit; and apply a second baseband pulse sequence to the second qubit; wherein the first baseband pulse sequence and the second baseband pulse sequence are temporally aligned according to the common clock signal.

According to some aspects, the techniques described herein relate to a method including: by at least one controller: generating a common clock signal; applying a first baseband pulse sequence to a first qubit; and applying a second baseband pulse sequence to a second qubit, wherein the first baseband pulse sequence and the second baseband pulse sequence are temporally aligned according to the common clock signal.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts an illustrative baseband pulse sequence, according to some embodiments;

FIG. 2A depicts a Bloch sphere representation;

FIGS. 2B-2D depict parameters of a baseband pulse sequence and their relationship to parameters of single-qubit gates, according to some embodiments;

FIG. 3 is a schematic of a system suitable for practicing aspects of the present disclosure, according to some embodiments;

FIG. 4 depicts a schematic of an illustrative system in which superconducting digital logic is configured to direct analog baseband pulse sequences to multiple qubits, according to some embodiments;

FIG. 5 depicts a schematic of an illustrative system in which superconducting digital logic is configured to direct analog baseband pulse sequences to a fluxonium qubit via a waveguide, according to some embodiments;

FIG. 6 depicts an illustrative approach for generating a digital baseband pulse sequence, according to some embodiments;

FIGS. 7A and 7B depict illustrative processes for generating analog baseband pulse sequences, according to some embodiments;

FIG. 8 depicts a number of clock cycles of a common clock signal and illustrative gates that may be applied to each of three qubits during these clock cycles, according to some embodiments;

FIG. 9 is a flowchart of a method of performing gates on qubits in synchrony with a common clock signal, according to some embodiments;

FIGS. 10A-10E depict aspects of calibrating parameters of a baseband pulse sequence that, when applied to a qubit, performs an

$$X ( \frac{π}{2} )$$

gate, according to some embodiments; and

FIG. 11 illustrates an example of a computing system environment on which aspects of the disclosure may be implemented.

### DETAILED DESCRIPTION

Qubits can be implemented in superconducting circuits that are engineered to exhibit two or more discrete quantum states at different energy levels. Superconducting qubits typically include one or more non-linear devices, such as Josephson junctions, so that only desired transitions between quantum states can be stimulated. Superconducting circuits also have the advantage of being non-dissipative at low temperatures.

There are several different types of superconducting qubits that exhibit distinct energy levels such that two of the energy levels can be mapped to the logical quantum states |0 [symbol] and |1 [symbol] . For instance, a charge qubit exhibits energy levels that correspond to different discrete amounts of charge in a small superconducting area, whereas a flux qubit exhibits energy levels that correspond to different persistent current states around a superconducting loop.

In some cases, the various types of superconducting qubits may be conventionally driven by microwave control pulses, which manipulate the quantum states of the qubits to perform quantum logic gates or other operations. For instance, a superconducting qubit is often driven by directing a microwave control pulse through one or more drive lines that are capacitively or inductively coupled to the superconducting qubit. These microwave control pulses are typically fast-oscillating and carefully tuned so that they have a frequency, phase, amplitude and envelope shape that will produce the desired operation on a qubit. The frequency and phase of the microwave control pulses must be controlled in a precise manner to produce the desired results. If these aspects of the signals are not produced accurately, the qubits may accumulate unwanted extra phase, leading to poor fidelity of operations. Moreover, qubits can often exhibit different resonant frequencies, such that the precise control of frequency and phase needs to be managed differently for different qubits. This type of control requires sophisticated microprocessors and other control electronics, in addition to signal routing to deliver control pulses to individual qubits. In other cases, the various types of superconducting qubits may be conventionally driven by baseband control signals, which must be applied to qubits with precise timing in when the pulse starts and stops being applied to a qubit (e.g., with around picosecond accuracy) to avoid imparting additional unwanted phase to a qubit during an operation.

As a result of these challenges, control of superconducting qubits conventionally requires a great deal of physical overhead, both in physical space and in thermal load, to route signals between qubits and room temperature, to provide cooling, and to provide sufficient electronics to generate highly tailored signals for each qubit. This physical overhead likely imposes physical space limits on the potential size of quantum processors of thousands of qubits. Yet, by most estimates, hundreds of thousands to millions of qubits will be needed to perform practically useful quantum computations.

The inventors have recognized and appreciated techniques for controlling qubits using baseband pulse sequences. In particular, many (or even all) qubits in a system can be controlled by baseband pulse sequences that are synchronized to a clock signal shared by the qubits. While the qubits may exhibit different resonant frequences, the baseband pulse control techniques described herein allow all the qubits to be driven with the same parameterized baseband pulse sequence applied based on the shared clock signal, with parameters of the baseband pulse sequence selected based on the desired operation. This approach greatly simplifies the electronics needed to drive a collection of qubits, as there is no need for picosecond timing, nor the complexities that arise from varied gate durations.

According to some embodiments, qubits may be controlled using baseband pulse sequences having a fixed duration and which are synchronized with the clock signal shared by the qubits (also referred to herein as a “common” clock signal). For instance, the common clock signal may have a rate of 50 MHz and the baseband pulse sequences applied to the qubits may each have a duration of 20 ns (that is, the length of one clock cycle). The baseband pulse sequences may therefore be temporally aligned according to the common clock signal, such as with each baseband pulse sequence being applied over the duration of one clock cycle. Any number of qubits, including all of the qubits, may be controlled in this manner using the same common clock cycle. As a result, applying the baseband pulse sequences to the qubits may have greatly simplified timing requirements compared with conventional approaches that finely tune pulse start times down to the picosecond level.

According to some embodiments, baseband pulse sequences may be generated based on digital templates. For instance, digital signal data may be manipulated and combined to produce a baseband pulse sequence, which is then applied to a qubit. The baseband pulse sequence produced may be a digital signal that is converted to an analog signal (e.g., via a digital to analog converter) that is applied to a qubit, or may be an analog signal that is applied to a qubit. As described further below, suitable baseband pulse sequences may be generated from primitive digital pulse sequences that have minimal data requirements, and which can be manipulated and combined to produce baseband pulse sequences that can perform a desired gate when applied to a qubit.

According to some embodiments, one or more baseband pulse sequences may be configured to perform an identity gate on a qubit. While conventionally it may not generally be necessary or desirable to apply identity gates to a qubit, application of the baseband pulse sequence techniques described herein may cause qubit states to change when no baseband pulse sequences are being applied to the qubits (e.g., because the qubits may accumulate unwanted extra phase). As a result, according to the techniques described herein, identity gates may be applied to a qubit to maintain its state when no other gates are otherwise being applied to the qubit. In some cases, this approach may mean that a baseband pulse sequence is always applied to a qubit during each clock cycle, where the baseband pulse sequence may represent a single-qubit gate, part of an entangling gate, or an identity gate. In these cases, a baseband pulse sequence may even be applied to every qubit in every clock cycle, with baseband pulse sequences representing identity gates being applied to a given qubit in every clock cycle when no change in that qubit's state is desired.

While illustrative examples are provided herein that relate to flux qubits, and particularly fluxonium qubits, the techniques described herein are generally applicable to any type of superconducting qubit, in addition to any other types of qubits where transitions between the qubit energy levels can be controlled by external control parameters such as voltage or current. Having said that, the techniques described herein may be particularly suited for use with fluxonium qubits, which have a comparatively low resonant frequency (e.g., around 100-200 MHz compared with frequencies of 4-8 GHz for many other superconducting qubits) and a large anharmonicity between energy levels.

Following below are more detailed descriptions of various concepts related to, and embodiments of, techniques for controlling qubits using baseband pulse sequences. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

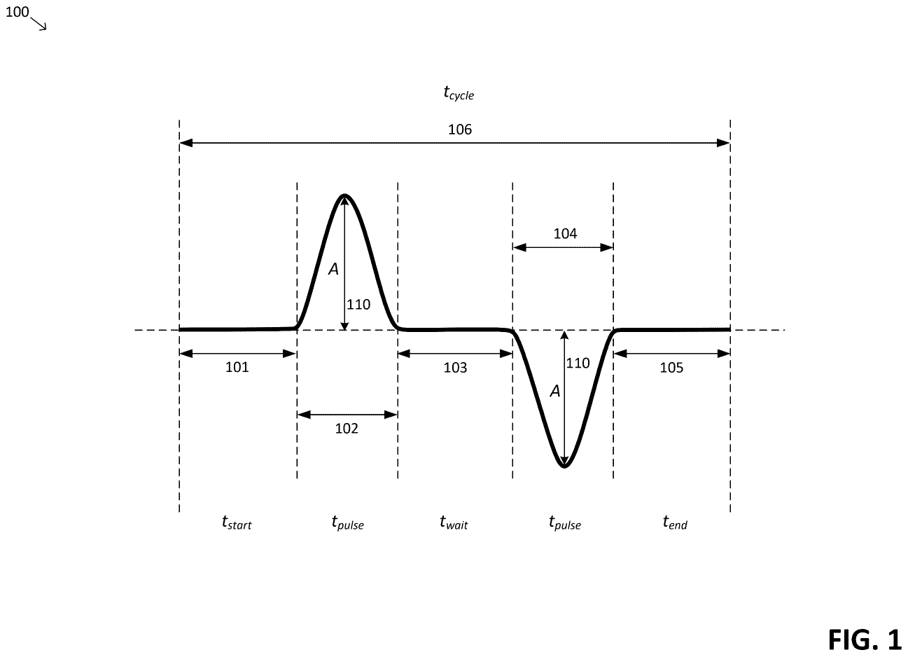

FIG. 1 depicts an illustrative baseband pulse sequence, according to some embodiments. To further describe the structure of the baseband pulse sequences that may be utilized by the techniques described herein, FIG. 1 depicts a baseband pulse sequence 100, which includes five distinct non-overlapping durations 101, 102, 103, 104 and 105, and which occur during the period 106 of the baseband pulse sequence. Time period 101, also referred to herein as tₛₜₐᵣₜ, is an initial period before a first pulse having amplitude 110, also referred to herein as A. The first pulse occurs during time period 102, also referred to herein as tₚᵤₗₛₑ. Time period 103, also referred to herein as t_{wait}, occurs between the first pulse and the second, negative, pulse which occurs in time period 104 and has a negative amplitude 110 (−A), and which also occurs within a duration tₚᵤₗₛₑ. Subsequent to the second pulse is a final time period 105, also referred to herein as t_{end}, up to the end of the baseband pulse sequence 100.

As described above, baseband pulse sequences such as baseband pulse sequence 100 may be applied to qubits in synchronization with a common clock signal, which in the example of FIG. 1 has a clock cycle of period 106, also referred to herein as t_{cycle}. As such, the length of t_{cycle} may be fixed at the length of one cycle of the common clock, such that the frequency of the common clock signal=1/t_{cycle}. For instance, if the common clock signal has a rate of 50 MHz, the duration of t_{cycle} is 20 ns. In addition, the duration of t_{cycle} may be written as a sum of its constituent time periods, i.e., t_{cycle}=tₛₜₐᵣₜ+2×tₚᵤₗₛₑ+t_{wait}+t_{end}. In some embodiments, tₛₜₐᵣₜ and t_{end} may be selected to be equal to one another, or to be approximately equal to one another. The periods tₛₜₐᵣₜ, t_{wait} and t_{end} may be referred to herein as “idle” periods during which the amplitude of the baseband pulse sequence is zero, or approximately zero.

As described in greater detail below, a baseband pulse sequence as shown in FIG. 1 (or a suitable approximation thereof), can be applied to a qubit to perform any desired single-qubit gate. In particular, the lengths of each of the durations within t_{cycle} may be adjusted (while maintaining the total time as t_{cycle}) and/or the amplitude A of the two pulses may be adjusted to control various aspects of a single-qubit gate, such as a rotation axis and/or a rotation angle. According to some embodiments, baseband pulse sequences as described herein may perform Landau-Zener gates when applied to a qubit.

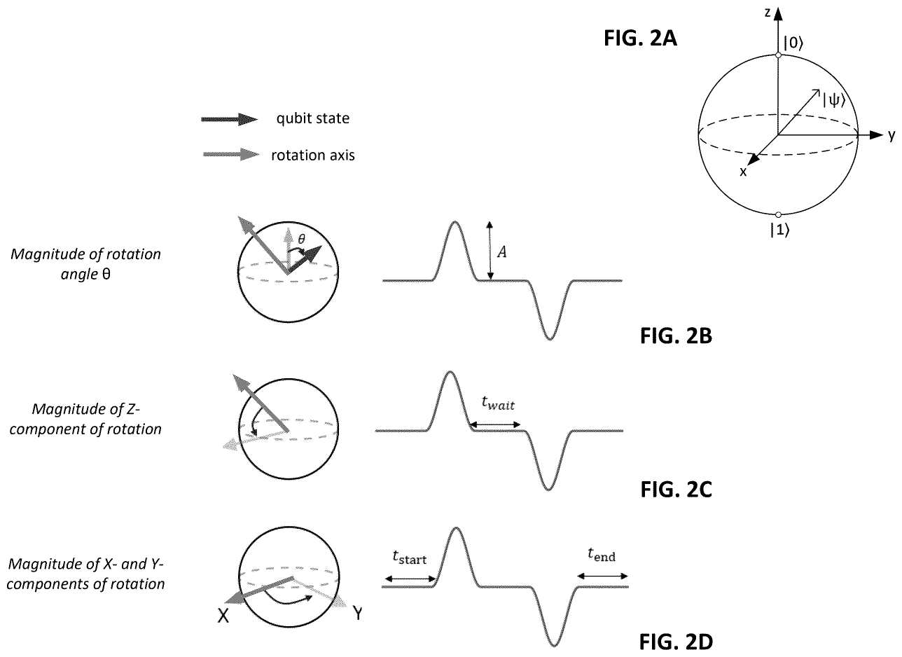

References to rotations of the state of a qubit refer to changes in the state of the qubit in the Bloch sphere representation, which is shown in FIG. 2A. In this representation, the computational basis states of the qubit |0 [symbol] and |1 [symbol] are poles of a sphere, and the state of the qubit |ψ [symbol] is represented by a vector to a point on the surface of the sphere, with points between the poles representing superpositions of the |0 [symbol] and |1 [symbol] states. Single-qubit gates may be viewed as rotations on the Bloch sphere, for example the

$$X ( \frac{π}{2} )$$

gate performs a rotation of

$$\frac{π}{2}$$

radians around the X axis.

Returning to the manner in which the parameters of a baseband pulse sequence may control various aspects of the gate, as shown in FIG. 2B, the amplitude 110 (A) may control the rotation angle θ of a single-qubit gate (although in some cases other aspects of the rotation, such as the rotation axis, may also have a dependence on the amplitude). As shown in FIG. 2C, the duration of time period 103 (t_{wait}) may control the Z-component of the rotation axis of a single-qubit gate. As shown in FIG. 2D, the duration of time periods 101 (tₛₜₐᵣₜ) and 105 (t_{end}) may control the X-component and Y-component of the rotation axis, respectively, of a single-qubit gate. It may be noted that since t_{cycle} is set by the frequency of the common clock signal, setting values of t_{wait}, tₛₜₐᵣₜ and t_{end} in effect dictates the duration of tₚᵤₗₛₑ.

In some embodiments, the frequency of the common clock signal is greater than or equal to 25 MHz, 50 MHz, 100 MHz, 150 MHz, 200 MHz, 250 MHz or 300 MHz. In some embodiments, the frequency of the common clock signal is less than or equal to 350 MHz, 300 MHz, 250 MHz, 200 MHz, 150 MHz, 100 MHz or 50 MHz. Any suitable combinations of the above-referenced ranges are also possible (e.g., the frequency of the common clock signal is greater or equal to 50 MHz and less than or equal to 150 MHz, etc.).

In some embodiments, the duration of tₚᵤₗₛₑ is greater than or equal to 0.5, 1 ns, 1.5 ns, 2 ns, 2.5 ns, 3 ns, 3.5 ns, 4 ns, 4.5 ns or 5 ns. In some embodiments, the duration of tₚᵤₗₛₑ is less than or equal to 5.5 ns, 5 ns, 4.5 ns, 4 ns, 3.5 ns, 3 ns, 2.5 ns, 2 ns, 1.5 ns, or 1 ns. Any suitable combinations of the above-referenced ranges are also possible (e.g., the duration of tₚᵤₗₛₑ is greater or equal to 3.5 ns and less than or equal to 4.5 ns, or the duration of tₚᵤₗₛₑ is greater or equal to 1.5 ns and less than or equal to 2 ns, etc.).

The above ranges may be applied to any of the baseband pulse sequences, or baseband pulse sequence generation techniques, described herein.

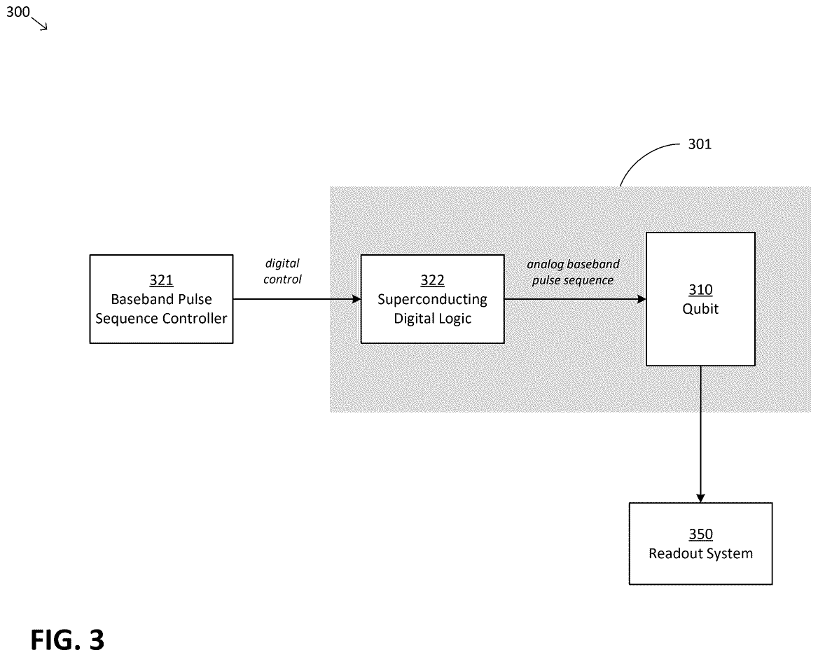

FIG. 3 is a schematic of a system suitable for practicing aspects of the present disclosure, according to some embodiments. System 300 includes a qubit 310 that may be controlled by the baseband pulse sequence controller 321 and the superconducting digital logic 322, which together generate an analog baseband pulse sequence and apply it to the qubit 310. A state of the qubit 310 may be measured via the readout system 350.

As referred to herein, “applying” an analog baseband pulse sequence to a qubit refers to directing an analog signal according to the baseband pulse sequence to one or more components that generate one or more interactions with the qubit. For instance, applying an analog baseband pulse sequence may comprise directing an electromagnetic wave (e.g., a microwave pulse) through a resonator coupled to the qubit, or may comprise directing a current signal through an antenna that produces a magnetic flux threaded through the qubit. Similarly, references herein to “applying” a gate to a qubit refer to applying an analog baseband pulse sequence to the qubit that has the effect of performing a particular gate on the qubit (e.g., changing its state in a particular way, or maintaining its state).

In the example of FIG. 3, the superconducting digital logic 322 and the qubit 310 are arranged within a low temperature stage 301 denoted by the shaded region, which may represent for instance a cryogenic environment below 4K, such as below 1K, or below 100 mK, or below 50 mK. Alternatively, the baseband pulse sequence controller 321 and/or readout system 350 may each be arranged partially within or wholly within the low temperature stage.

Although system 300 depicts a single grouping of: a qubit 310, baseband pulse sequence controller 321 and superconducting digital logic 322, it will be appreciated that in general a system for quantum computation or other quantum processes will contain many qubits, and as such system 300 could comprise many qubits. Moreover, either or both of the baseband pulse sequence controller 321 and the superconducting digital logic 322 may be coupled to any number of qubits in the manner shown in FIG. 3. For instance, a system may comprise a plurality (e.g., hundreds or thousands) of qubits 310, and the baseband pulse sequence controller 321 and the superconducting digital logic 322 may be coupled to any number (including all) of the qubits 310. Moreover, in such a system at least some of the plurality of qubits 310 may be coupled to other qubits of the plurality of qubits. The physical implementation of this coupling between qubits may depend on the particular type of qubit; for example, charge qubits may be coupled together via capacitive coupling or resonators, whereas flux qubits may be coupled together via inductive coupling and/or resonators. In some embodiments, at least some of the plurality of qubits 310 are coupled to other qubits of the plurality of qubits via a tunable coupler.

In the example of FIG. 1, qubit 310 may be a superconducting qubit, such as but not limited to, a charge qubit such as a transmon qubit, a gatemon qubit, or an Xmon qubit; a flux qubit such as a fluxonium qubit; or a phase qubit. In some cases, the qubit 310 may be a logical qubit formed from multiple physical qubits, such as a resonator coupled to an ancilla transmon qubit. In some embodiments, qubit 310 is a flux qubit, which comprises a superconducting circuit that exhibits energy eigenstates with different persistent currents depending on its flux bias. In some embodiments, the qubit 310 comprises a superconducting circuit arranged as a loop threaded by an external magnetic field and interrupted by a Josephson junction, such that the magnetic flux within the loop is proportional to a phase difference across the Josephson junction. For example, qubit 310 may be a fluxonium qubit, which comprises a Josephson junction, a capacitor and an inductor arranged in parallel with one another in a superconducting circuit, with an external magnetic flux threaded through the loop.

In the example of FIG. 3, the combination of baseband pulse sequence controller 321 and superconducting digital logic 322 is configured to manipulate quantum states of the qubit 310 (e.g., apply single-qubit gates to the qubit) by applying an analog baseband pulse sequence to the qubit. The analog baseband pulse sequence refers in general to a signal of some kind that produces interactions with the qubit, in some cases via a suitable coupling interface, examples of which are described below. The particular manner in which the analog baseband pulse sequence controls the state of the qubit may differ based on the type of qubit. For instance, in some embodiments the qubit 310 is a superconducting qubit and the combination of baseband pulse sequence controller 321 and superconducting digital logic 322 is configured to drive the superconducting qubit (and optionally one or more other such superconducting qubits) by directing an electromagnetic baseband pulse sequence through one or more drive lines (also called charge lines) that are capacitively coupled to the superconducting qubit (in this example, the drive lines may be considered a coupling interface to the qubit).

In some embodiments, the qubit 310 is a superconducting flux qubit and the combination of baseband pulse sequence controller 321 and superconducting digital logic 322 is configured to control the magnitude of a magnetic flux threaded through the flux qubit (also referred to herein as the magnitude of the flux bias of the flux qubit). For example, the combination of baseband pulse sequence controller 321 and superconducting digital logic 322 may be configured to control an external magnetic flux threaded through a superconducting loop that is part of the qubit 310. In some embodiments, the combination of baseband pulse sequence controller 321 and superconducting digital logic 322 is configured to independently control a plurality of magnetic flux biases that are threaded through respective different superconducting loops within the qubits 310. In some embodiments, control of an external magnetic flux comprises providing a baseline DC current signal that is fixed, in addition to providing the analog baseband pulse sequence generated by the superconducting digital logic 322 that modulates the baseline DC current signal. For instance, an antenna may be mutually inductively coupled to a superconducting loop of the qubit 310, and the analog baseband pulse sequence generated by the superconducting digital logic 322 may be provided to this antenna to modulate the magnetic flux threaded through the superconducting loop of the flux qubit. In some implementations, the superconducting digital logic 322 is configured in this manner and the qubit 310 is a fluxonium qubit. In these examples, the antenna may be considered a coupling interface to the qubit.

In the example of FIG. 3, the baseband pulse sequence controller 321 is configured to generate digital control data and supply that data to the superconducting digital logic 322, which is configured to generate the analog baseband pulse sequence based on the received digital control data. Generating the analog baseband pulse sequence in this way may include generating a digital signal by the superconducting digital logic 322 based on received digital control data, and converting the generated digital signal to an analog signal (e.g., via a digital to analog converter (DAC)), and/or may comprise generating an analog baseband pulse sequence based on received digital control data. Illustrative processes for generating analog baseband pulse sequences are described below.

According to some embodiments, the baseband pulse sequence controller 321 may be implemented using hardware (e.g., one or more Field Programmable Gate Arrays (FPGAs)), which may be collectively programmed and controlled by a general purpose computing system. In some embodiments, the baseband pulse sequence controller 321 may comprise hardware and/or software components configured to generate digital data in response to digital data generated or otherwise obtained by the readout system 350.

In some embodiments, the superconducting digital logic 322 comprises one or more digital devices, which may include a general purpose computing device and/or digital logic devices such as Application-Specific Integrated Circuits (ASICs) or FPGAs, and/or may include low temperature digital logic devices such as one or more cryo-CMOS, adiabatic quantum flux parametron (AQFP), single-flux quantum (SFQ), and/or quantum flux parametron (QFP) devices. In some embodiments, the superconducting digital logic 322 comprises an arbitrary waveform generator (AWG). In some embodiments, the superconducting digital logic 322 comprises a shift register implemented in low temperature digital logic, such as AQFP, which stores a digital input sequence supplied by the baseband pulse sequence controller 321. In some embodiments, the superconducting digital logic 322 comprises a digital to analog converter implemented in low temperature digital logic, such as AQFP, which directs analog baseband pulse sequences to each of a plurality of qubits 310 (e.g., modulates a plurality of independent flux bias lines) in accordance with a digital input sequence supplied by the baseband pulse sequence controller 321.

According to some embodiments, the superconducting digital logic 322 may operate in synchronization with a common clock signal, and may output analog baseband pulse sequences to one or more qubits 310 according to the common clock signal. For instance, baseband pulse sequences may be output by the superconducting digital logic 322 with a duration that is a multiple of the duration of the clock cycle of the common clock signal. Baseband pulse sequences output in this manner need not all have the same duration, e.g., some baseband pulse sequences may have a length of a single clock cycle, some baseband pulse sequences may have a length of two clock cycles, etc. Furthermore, the baseband pulse sequences may be applied to the qubit by the superconducting digital logic 322 such that each baseband pulse sequence is applied beginning at the start of a clock cycle of the common clock signal, and/or such that each baseband pulse sequence ends at the end of a clock cycle of the common clock signal.

According to some embodiments, the readout system 350 may include digital and analog components, wherein the analog components receive or otherwise generate an analog signal (e.g., a current signal, a voltage signal, etc.) in the readout system based on the state of the qubit 310, and wherein the digital components generate digital data based on the analog signal. Generating digital data in this way may include receiving or otherwise generating an analog signal in the readout system 350 and converting the analog signal to a digital signal (e.g., via an analog to digital converter (ADC)). In some embodiments, the readout system 350 may be an analog device configured to receive or otherwise generate an analog signal without converting this signal to a digital signal or generating a digital signal based thereon.

In some embodiments, the readout system 350 comprises one or more digital devices, which may include a general purpose computing device and/or digital logic devices such as ASICs or FPGAs, and/or may include low temperature digital logic devices such as one or more cryo-CMOS, adiabatic quantum flux parametron (AQFP), single flux quantum (SFQ), and/or quantum flux parametron (QFP) devices. As noted above, the readout system 350 may in some embodiments be partially arranged within the low temperature stage 301. For instance, the readout system 350 may comprise a room temperature computing device and/or a digital logic device coupled to a low temperature QFP circuit, which is configured to generate a digital signal based on an analog signal generated based on the state of the qubit 310.

In some embodiments, the readout system 350 comprises multiple inductively coupled devices that together generate a room temperature signal from low temperature electronics (e.g., QFP digital logic), which generate a signal based on the state of the qubit 310. As one example, the readout system 350 may comprise a quantum flux parametron (QFP) coupled to a DC superconducting quantum interference device (SQUID). In some embodiments, the readout system may comprise a resonator coupled to a feedline. For instance, a QFP circuit may be inductively coupled to a SQUID, which is connected in series with a quarter wave resonator, which is in turn capacitively coupled to a feedline. Any of these configurations for the readout system comprising flux-based superconducting digital logic, such as but not limited to QFP, may allow for classical electronics to measure the state of the qubit 310 inside the low temperature stage 301.

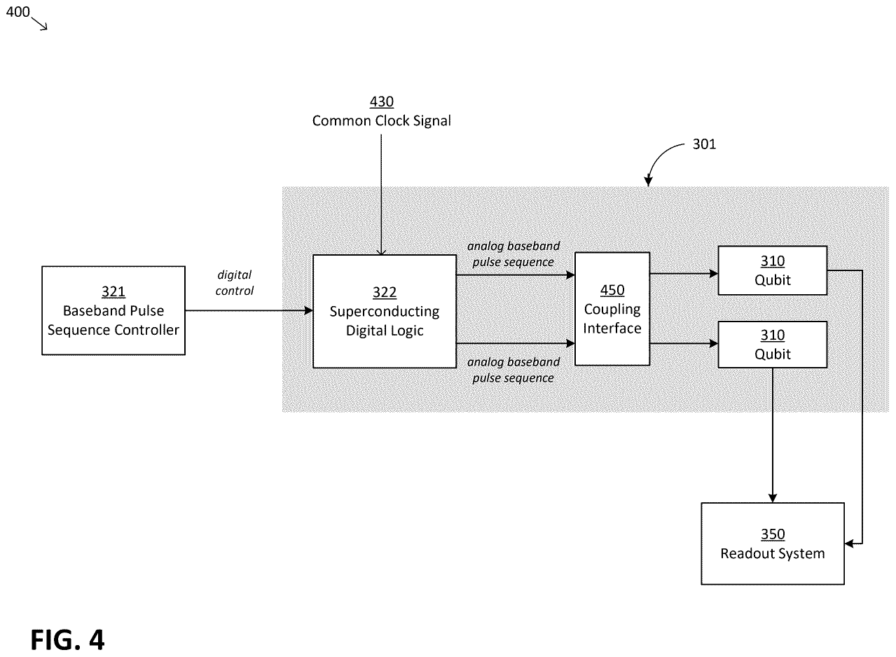

FIG. 4 depicts a schematic of an illustrative system in which the superconducting digital logic 322 is configured to direct analog baseband pulse sequences to multiple qubits, according to some embodiments. System 400 includes qubits 310 that may both be controlled by the baseband pulse sequence controller 321 and the superconducting digital logic 322, which together generate analog baseband pulse sequences and apply them to either or both of the qubits 310 via coupling interface 450. A state of either qubit 310 may be measured via the readout system 350. Moreover, the superconducting digital logic 322 receives a common clock signal 430, which allows the superconducting digital logic 322 to synchronize its output of the analog baseband pulse sequences according to the common clock signal.

In the example of FIG. 4, the coupling interface 450 is configured to produce interactions in the qubits 310 from respective analog baseband pulse sequences. Examples of suitable coupling interfaces are described above, but can in general be any collection of circuitry and other electronics components through which the analog baseband pulse sequences may be directed to produce an interaction with the qubit. The coupling interface 450 may include components that are independently coupled to one of the qubits 310 and/or may include components that are coupled to multiple of the qubits 310 and which may be operated to control any of a group of qubits 310.

Extensions to system 400 including many more qubits may readily be envisioned. Such systems may be controlled by a single superconducting digital logic 322 or by multiple of superconducting digital logic 322 operating together. In the case of multiple superconducting digital logic 322, each superconducting digital logic may be synchronized to the same common clock signal 430. As described above, this configuration allows for greatly simplified electronics needed to drive a collection of qubits compared with conventional baseband control pulses that must be precisely timed and managed separately for each qubit.

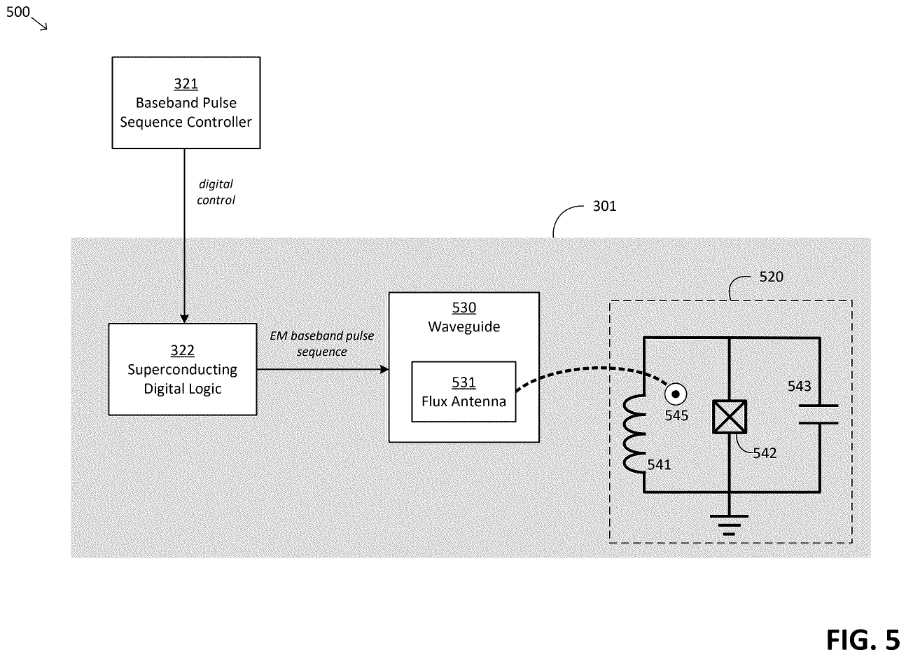

FIG. 5 depicts a schematic of an illustrative system in which the superconducting digital logic 322 is configured to direct analog baseband pulse sequences to a fluxonium qubit via a waveguide, according to some embodiments. System 500 provides an example of the baseband pulse sequence controller 321 and superconducting digital logic 322 shown in FIGS. 3 and 4, with a waveguide 530 as the coupling interface 450 to a qubit 310, which in the example of FIG. 5 is a fluxonium qubit 520.

In the example of FIG. 5, the fluxonium qubit 520 comprises a superconducting loop with a capacitor 543, a Josephson junction 542, and an inductor 541 arranged in parallel with one another. A flux bias 545 is threaded through the superconducting loop, and may be independently controlled by the superconducting digital logic 322 producing an electromagnetic baseband pulse sequence in waveguide 530 (e.g. a waveguide that is coplanar with the fluxonium qubit 520). The waveguide 530 comprises (e.g., at one end) the flux antenna 531, which is inductively coupled to the superconducting loop of the fluxonium qubit 520.

During operation of system 500, a baseband pulse sequence generated by the baseband pulse sequence controller 321 and superconducting digital logic 322 is transmitted as an electromagnetic wave (e.g., microwave) that propagates through the waveguide 530. This wave produces a signal from the flux antenna 531, which through its inductive coupling with the superconducting loop, produces and/or modulates the magnetic flux 545 threaded through the loop. In some embodiments, the superconducting digital logic 322, or another component in system 500, provides a baseline signal to the flux antenna 531 via the waveguide 530, such that the baseband pulse sequence provided to the flux antenna modulates this baseline signal.

In at least some cases, the baseband pulse sequence shown in FIG. 1 represents an idealized waveform that may be difficult to produce in practice. For instance, it may not be feasible to produce a smooth waveform like that shown in FIG. 1 because the sampling frequency of the digital waveform is not significantly larger than the frequency of the common clock signal. Following below are illustrative processes and system for forming a digital waveform that is an approximation of the baseband pulse sequence shown in FIG. 1.

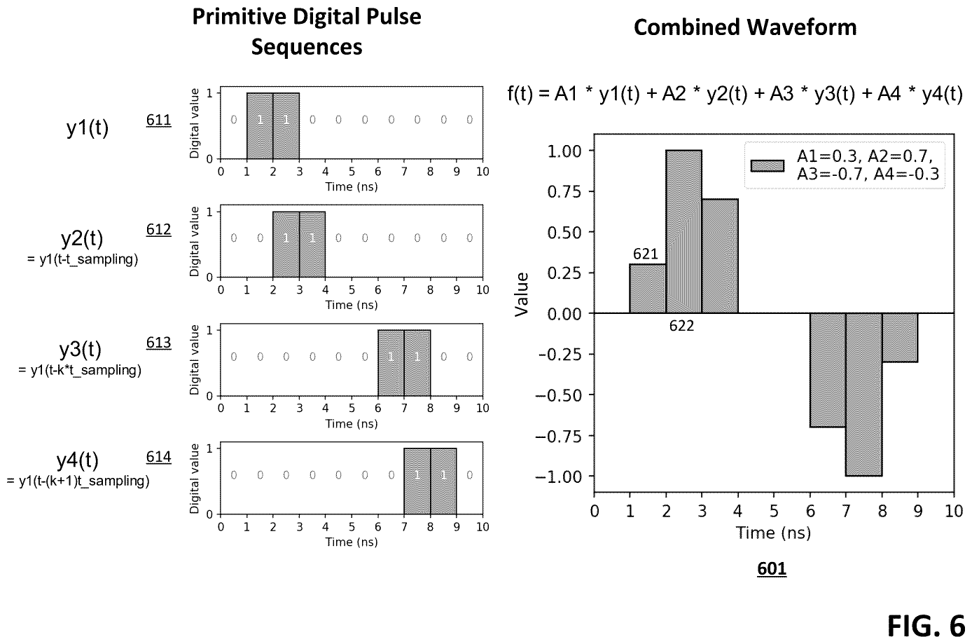

FIG. 6 depicts an illustrative approach for generating a digital baseband pulse sequence, according to some embodiments. In the example of FIG. 6, a waveform 601 is generated with a duration of 10 nanoseconds (ns) by amplitude-scaling and combining four primitive digital pulse sequences 611, 612, 613 and 614. This process may be performed by, for instance, the superconducting digital logic 322 as shown in any of the systems 300, 400 or 500 shown in FIG. 3, 4 or 5. For instance, the superconducting digital logic 322 may store, or otherwise have access to, the primitive digital pulse sequences 611, 612, 613 and 614 (e.g., in a non-transitory digital memory) and may generate the waveform 601 based on digital data (e.g., a set of amplitudes) received from the coupled baseband pulse sequence controller 321.

In the example of FIG. 6, the duration of t_{cycle} is 10 ns, representing a single clock cycle of a common clock signal with frequency 100 MHz. The waveform 601 is built from 10 digital values sampled at a frequency of 1 GHZ, and the digital values are determined by amplitude-scaling the primitive digital pulse sequences 611-614.

In the example of FIG. 6, the first two primitive digital pulse sequences 611 and 612, also labeled y1(t) and y2(t), control the timing of the first pulse in waveform 601, and are amplitude-scaled and combined to form the positive amplitude pulse in the baseband pulse sequence. As shown in FIG. 6, the primitive digital pulse sequences 611-614 are structured as square-waves with digital values of 1 at two time points, and with digital values of 0 at other time points. Advantageously, since the primitive digital pulse sequences 611-614 are time-shifted versions of the same digital waveform in the example of FIG. 6, only a single digital primitive need be stored in memory if desired, and this single primitive digital pulse sequence can be time-shifted to produce the set of primitive digital pulse sequences 611-614.

In the example of FIG. 6, the waveform 601 is generated from the primitive digital pulse sequences 611-614 by scaling each of the primitive digital pulse sequences according to respective amplitudes A₁=0.3, A₂=0.7, A₃=−0.7 and A₄=−0.3. For instance, the digital value 621 is generated from the first digital value of the primitive digital pulse sequence 611 scaled by the amplitude A₁=0.3, thereby producing a digital value of 0.3; and the digital value 622 is generated from the second digital value of the primitive digital pulse sequence 611 scaled by the amplitude A₁=0.3, added to the first digital value of the primitive digital pulse sequence 612 scaled by the amplitude A₂=0.7, thereby producing a digital value of 1.0. As such, the overall amplitude of the first pulse is the sum of amplitudes A₁ and A₂, and similarly, the overall amplitude of the second pulse is the sum of amplitudes A₃ and A₄.

According to some embodiments, a system generating an analog baseband pulse sequence may generate the waveform of the analog baseband pulse sequence based on a digital waveform representing the baseband pulse sequence. For example, the superconducting digital logic 322 as shown in any of the systems 300, 400 or 500 shown in FIG. 3, 4 or 5 may generate the analog baseband pulse sequence by providing a generated digital waveform (e.g., waveform 601 in the example of FIG. 6) to a digital-to-analog converter (DAC).

Alternatively, according to some embodiments, a system generating an analog baseband pulse sequence may generate the waveform of the analog baseband pulse sequence by combining a plurality of primitive analog pulse sequences each generated from a corresponding primitive digital pulse sequence. For example, the analog baseband pulse sequence waveform may be generated by converting each of a plurality of primitive digital pulse sequences (e.g., primitive digital pulse sequences 611-614) into analog pulse sequences, such as by converting each of the amplitude-scaled primitive digital pulse sequences into a respective primitive analog pulse sequence with a DAC, and combining the primitive analog pulse sequences with analog hardware to produce the analog baseband pulse sequence.

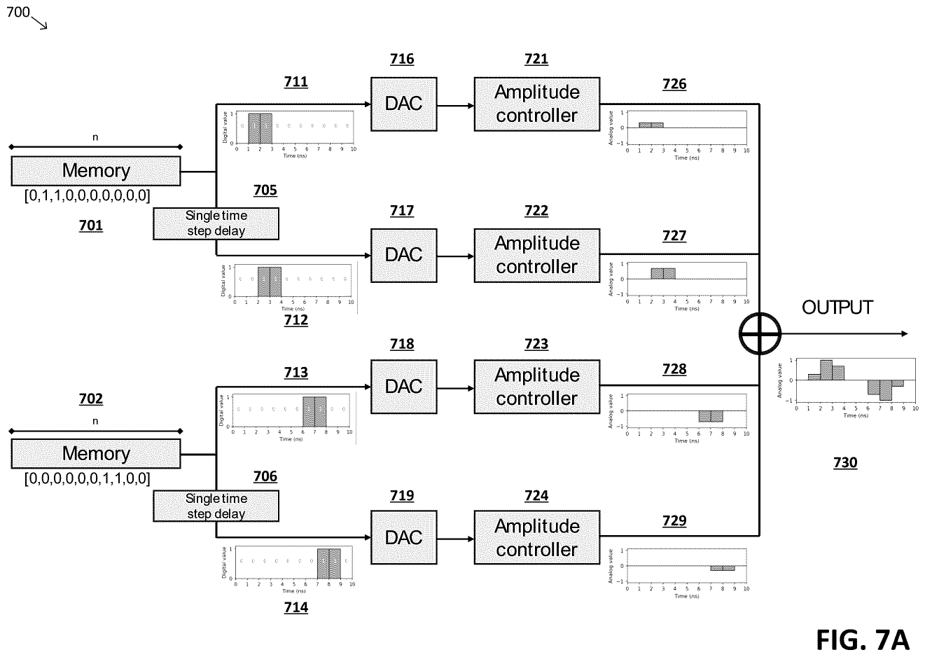

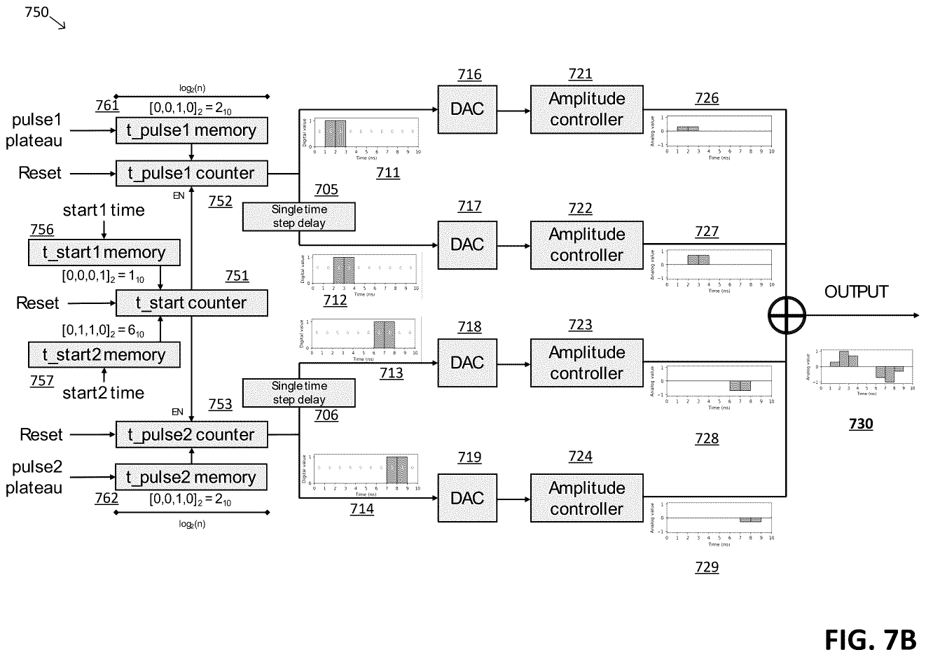

FIGS. 7A and 7B provide illustrative examples of how a system, such as the superconducting digital logic 322 as shown in any of the systems 300, 400 or 500 shown in FIG. 3, 4 or 5, may be configured to generate analog baseband pulse sequences, according to some embodiments. The illustrative systems 700 and 750 shown in FIGS. 7A and 7B, respectively, are described in terms of the illustrative waveform generation process of FIG. 6, though it will be appreciated that these systems could be readily modified to use different primitive digital pulse sequences, sampling frequencies, amplitude scalings, etc.

In the example of FIG. 7A, system 700 comprises two N-wide shift-register-based waveform memories 701 and 702, which store the digital sequences y1(t) and y3(t) as shown. The digital sequences y2(t) and y4(t) are generated by time-shifting y1(t) and y3(t) using single time-step delay components (e.g., D flip-flops) 705 and 706. This produces the primitive digital pulse sequences 711, 712, 713 and 714, which are provided to DACs 716, 717, 718 and 719, respectively. The output of each DAC is independently amplitude-scaled with amplitude controllers 721, 722, 723 and 724 to produce primitive analog pulse sequences 726, 727, 728 and 729, respectively. These analog waveforms are combined to produce the analog baseband pulse sequence 730. According to some embodiments, each of amplitude controllers 721, 722, 723 and 724 may be magnetically coupled to a common inductor output line via a transformer to combine the analog waveforms produced by the amplitude controllers, and generate the analog baseband pulse sequence 730.

According to some embodiments, the amplitude controllers 721, 722, 723 and 724 may each be configured to receive a digital value indicative of an amplitude scaling to apply to the analog signals received from the respective DACs 716, 717, 718 and 719. For example, a superconducting digital logic 322 may be configured as shown in FIG. 7A and may be configured to receive digital data from a baseband pulse sequence controller 321.

According to some embodiments, a minimum amount of memory needed to generate the analog baseband pulse sequence 730 may be 2N+4M bits, where the number of time samples in each primitive digital pulse sequences 701 and 702 is N bits, and the amplitude input to each amplitude controller is M bits. This is significantly less than the N*M bits of memory that would be needed to generate the analog baseband pulse sequence 730 using arbitrary waveform generation, for example. For example, when N=100, M=15, the system configuration of FIG. 7A requires 2N+4M=260 bits of memory, whereas arbitrary waveform generation would require N*M=1,500 bits of memory.

As an alternative to FIG. 7A, system 700 shown in FIG. 7B comprises incrementing counters configured to generate primitive digital pulse sequences, instead of storing these in N-wide shift register memories. In the example of FIG. 7B, system 750 comprises counters 751, 752 and 753. The counter 751 controls the start times of the first and second pulses of the baseband pulse sequence waveform, and utilizes two log 2(N)-wide memories 756 and 757 each storing the start time threshold for one of the two pulses.

For the first pulse in the baseband pulse sequence, when the counter 751 reaches the start time threshold stored in memory 756, the counter 751 creates an enable signal (EN) to activate pulse counter 752. Pulse counter 752 generates a digital logic ‘1’ at each time step to generate the plateau of the first pulse in the baseband pulse sequence. Another log 2(N)-wide memory 761 defines how long the plateau of the first pulse of the baseband pulse sequence lasts. When the counter 752 reaches this threshold stored in memory 761, the counter 752 stops generating a 1 at each time step, thus ending the plateau of the pulse. The formation of the second pulse in the baseband pulse sequence is similar to that of the first pulse, except that the generation of the enable signal (EN) to activate the corresponding counter 753 is determined by the threshold set in the memory 757 and the pulse plateau is governed by the counter 753 and the plateau value set in memory 762.

These components thereby produce the same data as was stored in memories 701 and 702 in the example of FIG. 7A. The remainder of system 750 is configured to generate the analog baseband pulse sequence 730 in the same way as the identically-labeled components in system 700. For instance, the primitive digital pulse sequence 712 is generated by time-shifting the signal produced from the counter 752 using single time-step delay component 705, which is converted to an analog signal using DAC 717, and amplitude-scaled by amplitude controller 722, etc.

In the approach of FIG. 7B, a total of three log 2(N)-wide counters 751, 752 and 753, and four log 2(N)-wide memories 756, 757, 761 and 762 are included in system 750. These components, combined with the amplitude input to each amplitude controller of M bits, result in system 750 having a total memory requirement of 7 log 2(N)+4M bits. This amounts to, for example, 109 bits of memory when N=100, M=15 (compared with 260 bits for system 700 in the same example).

It may further be possible to modify system 750 further to include ultra-fine grained multithreading at the circuit-level, which would allow all of the counters to be merged into a single shared counter clocked at three times the nominal frequency of the waveform generator. This allows time-multiplexing on a single shared counter to perform three independent counts to control the following: (1) the start time of the two pulses via two tₛₜₐᵣₜ thresholds, (2) the plateau of the first pulse of the baseband pulse sequence, and (3) the plateau of the second pulse of the baseband pulse sequence. This approach would further reduce the minimum amount of memory needed to 5 log 2(N)+4M, e.g., about 95 bits for N=100, M=15.

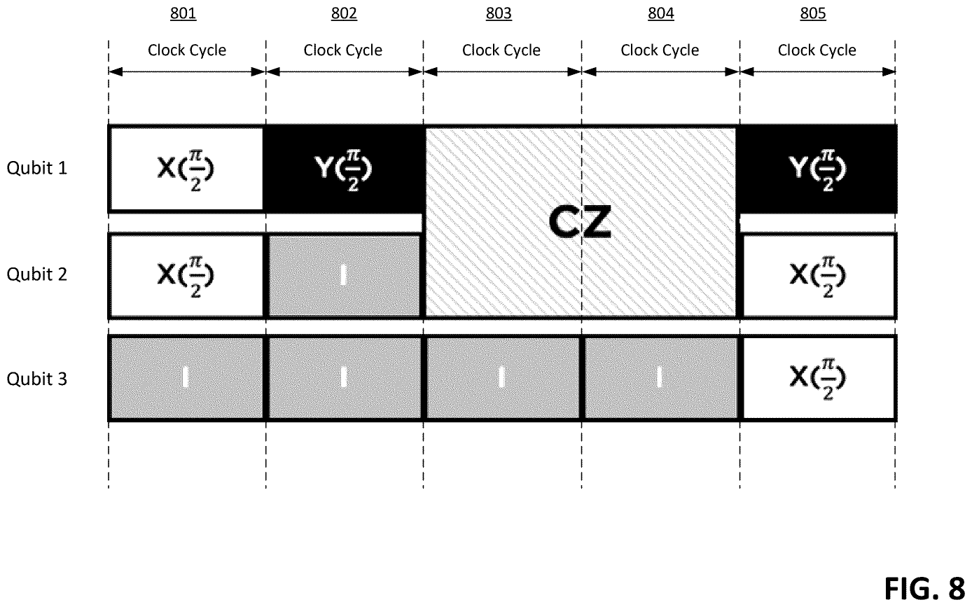

FIG. 8 depicts a number of clock cycles of a common clock signal and illustrative gates that may be applied to each of three qubits during these clock cycles, according to some embodiments. As described above, in some cases a system (e.g., system 300, 400 or 500 shown in FIGS. 3, 4 and 5 respectively) may be configured to synchronize application of baseband pulse sequences to multiple qubits with a common clock signal such that the baseband pulse sequences can be applied to each qubit simultaneously at the start of a given clock cycle.

In the example of FIG. 8, each baseband pulse sequence is represented by a rectangle labeled with the operation being performed as a result of application of the baseband pulse sequence. For example, in the example of FIG. 8, during the first illustrated clock cycle 801, an

$$X ( \frac{π}{2} )$$

gate is performed on qubit 1, an

$$X ( \frac{π}{2} )$$

gate is performed on qubit 2, and an Identity gate I is performed on qubit 3. The system applying the baseband pulse sequences that produce these gates is configured to apply a respective baseband pulse sequence to each of the three qubits within the time window of the clock cycle 801, as described above. For example, an analog baseband pulse sequence of the form of the baseband pulse sequence 100 shown in FIG. 1 may be applied to each of the three qubits independently, with the timing and/or amplitude of each baseband pulse sequence selected to produce the respective desired gate. As will be described below, the parameters of the baseband pulse sequence may be calibrated to perform different gates, so that performing a particular gate may comprise selecting the predetermined calibrated values of t_{wait}, tₛₜₐᵣₜ, t_{end} and A that produce the desired gate (or otherwise generating a waveform that exhibits the desired values t_{wait}, tₛₜₐᵣₜ, t_{end} and A of by selecting values of suitable parameters different from t_{wait}, tₛₜₐᵣₜ, t_{end} and A and generating the baseband pulse sequence based on those parameters).

Also in the example of FIG. 8, a CZ entangling gate is applied to qubits 1 and 2 over two clock cycles 803 and 804. For example, in each of clock cycles 803 and 804, a baseband pulse sequence may be applied to each of qubits 1 and 2 so that the net effect of those four baseband pulse sequences is to perform a CZ gate on qubits 1 and 2. The CZ gate in clock cycles 803 and 804 in FIG. 8 is an example of a gate performed over multiple clock cycles through application of multiple baseband pulse sequences.

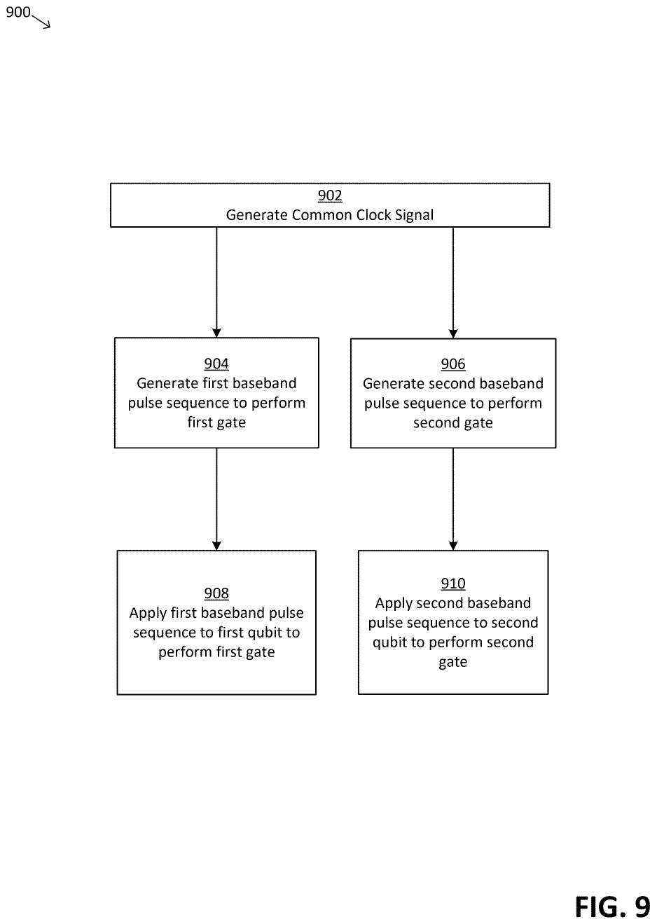

FIG. 9 is a flowchart of a method of performing gates on qubits in synchrony with a common clock signal, according to some embodiments. Method 900 may be performed by any system configured to apply baseband pulse sequences as described herein to qubits in synchrony with a common clock signal, such as system 300, 400 or 500 depicted in FIGS. 3, 4 and 5 respectively. In act 902, the system performing method 900 generates a common clock signal that will dictate the timing of baseband pulse sequences that will be applied to the qubits. It will be appreciated that the common clock signal may be operated on an ongoing basis and need not be started in act 902 at any particular time relative to the other acts of method 900.

In acts 904 and 906, baseband pulse sequences are generated to perform gates on two qubits. In particular, in act 904 a first baseband pulse sequence is generated to perform a first gate on a first qubit, and in act 906 a second baseband pulse sequence is generated to perform a second gate on a second qubit. Each of the first and second baseband pulse sequences may be generated as described above. In particular, a superconducting digital logic such as the superconducting digital logic 322 as shown in any of the systems 300, 400 or 500 shown in FIG. 3, 4 or 5 may be operated at a frequency of the common clock signal and/or at a frequency that is an integer multiple of the common clock signal. For example, in the above example of FIGS. 6 and 7A-7B, the common clock signal is 100 MHz and the sampling frequency of the superconducting digital logic is 1 GHz so there are ten digital values generated within each clock cycle. Though, any suitable combination of common clock signal frequency and sampling frequency may be selected.

In the example of FIG. 9, first and second baseband pulse sequences in acts 904 and 906, respectively, are generated based at least in part on the first gate and second gate, respectively, to be performed. For instance, either or both of act 904 or 906 may comprise selecting one or more values associated with a gate to be performed, and generating the baseband pulse sequences based on the selected one or more values. In some embodiments, either or both of act 904 or 906 comprises determining values of one or more parameters that parameterize the timing, shape, and/or amplitude of a baseband pulse sequence. Suitable values to be selected in acts 904 and/or 906 may include digital values input to a superconducting digital logic performing at least part of method 900, and/or values representing durations and/or amplitudes of portions of the baseband pulse sequence.

In acts 908 and 910, the baseband pulse sequences generated in acts 904 and 906, respectively, are applied to the first and second qubits, respectively.

Generation of the baseband pulse sequences in acts 904 and 906 may comprise generating digital values during cycles of a sampling clock so that baseband pulse sequences are continually being generated and output. That is, the separation of acts 904 and 906 in FIG. 9 with subsequent acts 908 and 910 in which the baseband pulse sequences are applied to the qubits is not intended to suggest that generation of a baseband pulse sequence must be completed before any part of that baseband pulse sequence is applied to a qubit.

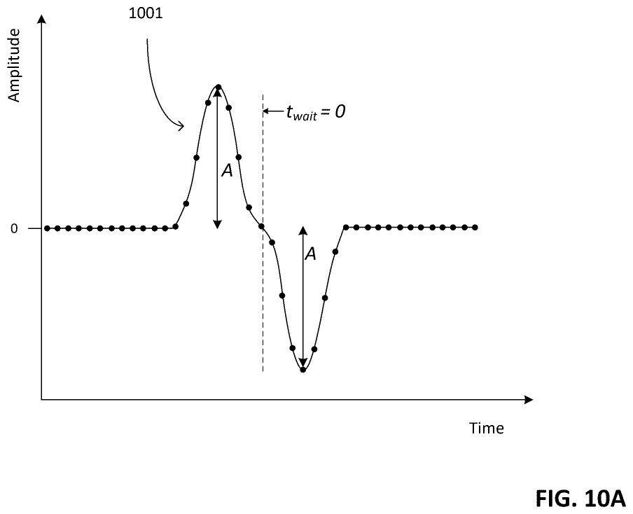

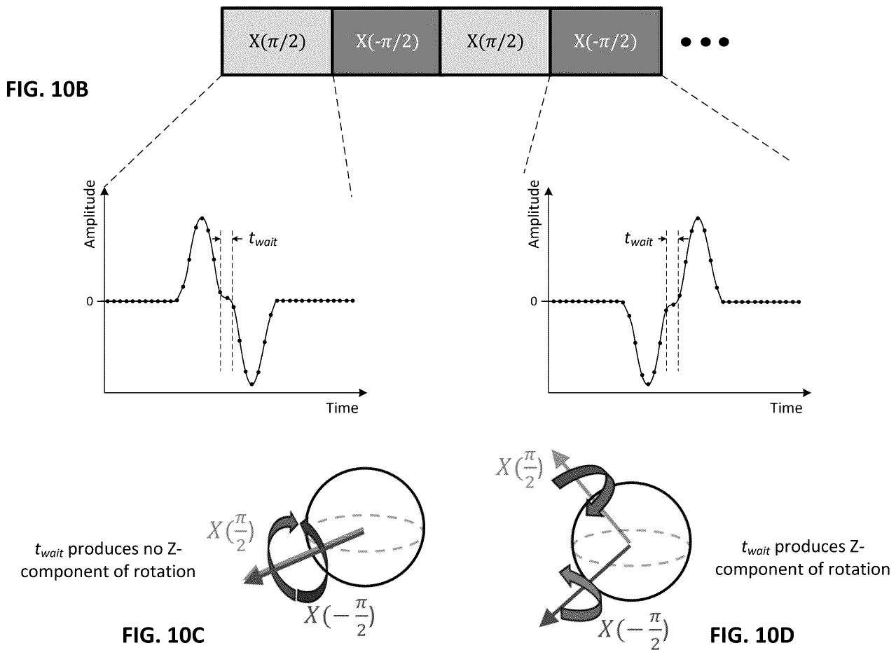

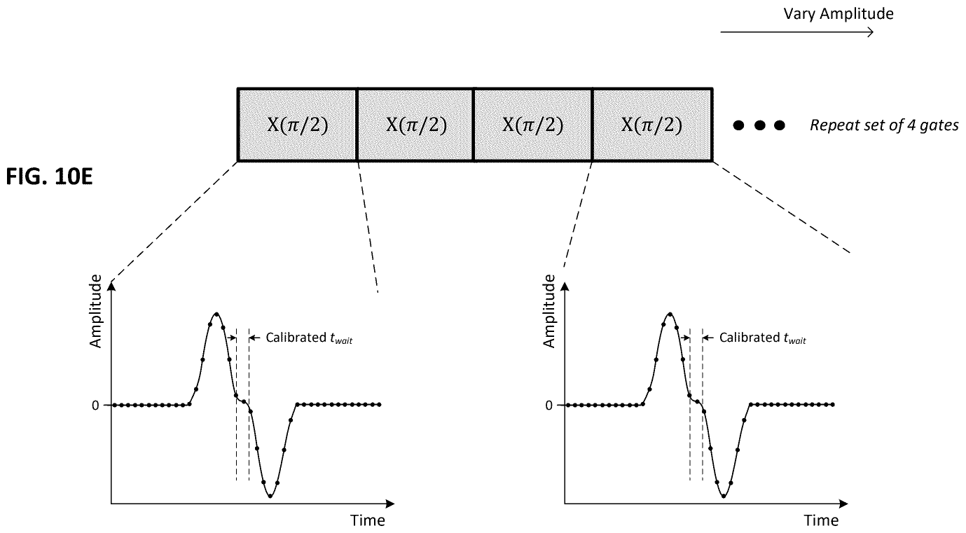

To provide one example of how a baseband pulse sequence's parameters may be calibrated to perform a desired gate, FIGS. 10A-10D depict aspects of calibrating parameters of a baseband pulse sequence that, when applied to a qubit, performs an

$$X ( \frac{π}{2} )$$

gate, according to some embodiments.

FIG. 10A depicts a baseband pulse sequence over 40 cycles of a sampling clock, in which the time period between the two pulses t_{wait} is zero. In FIG. 10A, the solid line represents an interpolated waveform, whereas the digital values that form the baseband pulse sequence are shown as small circles. To calibrate the amplitude of a baseband pulse sequence that will produce an

$$X ( \frac{π}{2} )$$

gate, the baseband pulse sequence 1001 depicted in FIG. 10A is applied to a qubit that has been initialized in the |0 [symbol] state. The population of the |1 [symbol] state of the qubit is measured, for various values of the amplitude A of the baseband pulse sequence. The calibrated value of the amplitude A is the value for which application of the baseband pulse sequence produces a 50% population of the |0 [symbol] state, and a 50% population of the |1 [symbol] state when measured.

Subsequently, a sequence of

$$X ( \frac{π}{2} )$$

gates alternated with

$$X ( - \frac{π}{2} )$$

gates are applied to the qubit to calibrate t_{wait}, which dictates the Z-axis component of a rotation around the Bloch sphere. These gates are applied by selecting a value of t_{wait} and applying a first baseband pulse sequence to the qubit with this value of t_{wait} and an amplitude A, then applying a second baseband pulse sequence to the qubit with the same value of t_{wait} and an amplitude −A. These two pulses are shown in FIG. 10B, with the first baseband pulse sequence for the

$$X ( \frac{π}{2} )$$

gate depicted on the left, and with the second baseband pulse sequence for the

$$X ( - \frac{π}{2} )$$

gate depicted on the right, being an amplitude-inverted version of the first baseband pulse sequence. This sequence of

$$X ( \frac{π}{2} )$$

gate followed by an

$$X ( - \frac{π}{2} )$$

gate can be repeated a number of times during calibration.

The desired value of t_{wait} when calibrating the

$$X ( \frac{π}{2} )$$

gate is the value of t_{wait} in baseband pulse sequences applied to the qubit that results in a rotation with no Z-axis component, i.e., where the rotation axis lies in the X-Y plane. For other values of t_{wait}, the axis of rotation of the baseband pulse sequence representing a

$$X ( \frac{π}{2} )$$

gate will include a Z-component in addition to an X-component and/or a Y-component, and the axis of rotation of the baseband pulse sequence representing a

$$X ( - \frac{π}{2} )$$

gate will include the same X-component and/or Y-component, but will include a Z-component having an opposite sign as the

$$( \frac{π}{2} )$$

gate. As such, the axes or rotation of the

$$X ( \frac{π}{2} )$$

gate and the

$$X ( - \frac{π}{2} )$$

gate will be different when t_{wait} is not calibrated to produce no Z-component of the rotation. An example of these two axes of rotation is shown in FIG. 10D. In contrast, when t_{wait} is calibrated to produce no Z-component of the rotation, the axes will be the same as shown in FIG. 10C. This means that, when t_{wait} is calibrated to produce no Z-component of the rotation (as in FIG. 10C), performing a gate

$$X ( \frac{π}{2} )$$

followed by a

$$X ( - \frac{π}{2} )$$

gate should result in no change to the state of the qubit, whereas when t_{wait} is not calibrated to produce no Z-component of the rotation (as in FIG. 10D), performing a

$$X ( \frac{π}{2} )$$

gate followed by a

$$X ( - \frac{π}{2} )$$

gate will result in a net change to the state of the qubit.

As such, the desired value of t_{wait} when calibrating the

$$X ( \frac{π}{2} )$$

gate may be determined by performing a sequence of a

$$X ( \frac{π}{2} )$$

gate followed by a

$$X ( - \frac{π}{2} )$$

gate, any number of times. In some cases, the amplitude of the baseband pulse sequences may be changed through this sequence so long as each pair of

$$X ( \frac{π}{2} )$$

gate and

$$X ( - \frac{π}{2} )$$

gate have equal and opposite amplitudes. When t_{wait} is calibrated, this pair of gates should not result in a net change to the state of the qubit, irrespective of the amplitude, because whatever rotation angle is applied in the

$$X ( \frac{π}{2} )$$

gate will be applied by the

$$X ( - \frac{π}{2} )$$

gate in the reverse direction. According to some embodiments, the initial state of the qubit when beginning the gate sequence shown in FIG. 10B may be the |0 [symbol] or |1 [symbol] state, since these states may be conveniently measured at the end of the sequence, but in general the qubit may be initialized in any known state before the sequence begins.

To more accurately calibrate the amplitude, a set of 4

$$X ( \frac{π}{2} )$$

gates are applied to the qubit that is initialized in a known state, such as the |0 [symbol] or |1 [symbol] state, using the calibrated value of t_{wait} for the

$$X ( \frac{π}{2} )$$

gate. If the amplitude is properly calibrated for the

$$X ( \frac{π}{2} )$$

gate, four

$$X ( \frac{π}{2} )$$

gates in a row will return the quit to its initial state. This set of 4

$$X ( \frac{π}{2} )$$

gates, as shown in FIG. 10E, may be applied to the qubit any number of times before the state of the qubit is measured, and an amplitude may be selected for each sequence of

$$X ( \frac{π}{2} )$$

gates. The calibrated amplitude may be determined by finding the amplitude of the baseband pulse sequences that will retain the initial state, even after performing many multiples of 4

$$X ( \frac{π}{2} )$$

gates, such as 80

$$X ( \frac{π}{2} )$$

gates. tₛₜₐᵣₜ and t_{end} may be calibrated for the

$$X ( \frac{π}{2} )$$

gate in a similar manner to t_{wait} described above to calibrate the Y-axis component of the rotation, and may in some cases be calibrated while keeping the values of tₛₜₐᵣₜ and t_{end} equal.

Other gates, such as the

$$Y ( \frac{π}{2} )$$

gate and the I gate (identity gate) may also be calibrated in a similar manner. For instance, to calibrate the I gate, the values of tₛₜₐᵣₜ and t_{end} that produce no X-component or Y-component of a rotation may also be determined. The amplitude A and t_{wait} for the calibrated I gate may be determined by performing a sequence of

$$X ( \frac{π}{2} ) , I , X ( - \frac{π}{2} ) ,$$

and determining which combination of values of A and t_{wait} minimize any change to the state of the qubit. For instance, when the qubit is initialized in the |0 [symbol] state, determining which values of A and t_{wait} produce the |0 [symbol] 22 state with the highest fidelity after many applications of the

$$X ( \frac{π}{2} ) , I , X ( - \frac{π}{2} )$$

gate sequence may indicate calibrated values of A and t_{wait}.

With respect to the

$$Y ( \frac{π}{2} )$$

gate, a sequence of

$$[ X ( \frac{π}{2} ) , Y ( \frac{π}{2} ) ]$$

may be performed three times in succession with a given value of tₛₜₐᵣₜ. When the value of tₛₜₐᵣₜ for the

$$Y ( \frac{π}{2} )$$

gate is calibrated correctly, the sequence of

$$[ X ( \frac{π}{2} ) , Y ( \frac{π}{2} ) ]$$

performed three times will produce no change in the state of the qubit (that is, it is equivalent to the identity gate I).

As such, the value of tₛₜₐᵣₜ for the

$$Y ( \frac{π}{2} )$$

gate may be calibrated by varying tₛₜₐᵣₜ while repeatedly performing the sequence of

$$[ X ( \frac{π}{2} ) , Y ( \frac{π}{2} ) ] .$$

three times in succession, to determine the value of tₛₜₐᵣₜ that minimizes the change in the qubit's state. The values of A and t_{wait} for the

$$Y ( \frac{π}{2} )$$

gate may then be calibrated in a similar manner to the

$$X ( \frac{π}{2} )$$

calibration described above. That is, the amplitude A is calibrated by performing four

$$Y ( \frac{π}{2} )$$

gates and finding the amplitude that will return the qubit to its initial state, and t_{wait} is calibrated by performing a sequence of a

$$Y ( \frac{π}{2} )$$

gate followed by a

$$Y ( - \frac{π}{2} )$$

gate and finding the value of t_{wait} that will return the qubit to its initial state.

As referred to herein, a “qubit” includes any multi-level quantum-mechanical system capable of being controlled by a quantum information processor. The quantum states of the qubit may for instance include electronic states, polarization states, vibrational states, rotational states, or spin states. As referred to herein, a “superconducting qubit” includes any superconducting electronic circuit that may be operated as a multi-level quantum-mechanical system, such as a charge qubit (e.g., a transmon), a flux qubit (e.g., a fluxonium qubit), or a phase qubit.

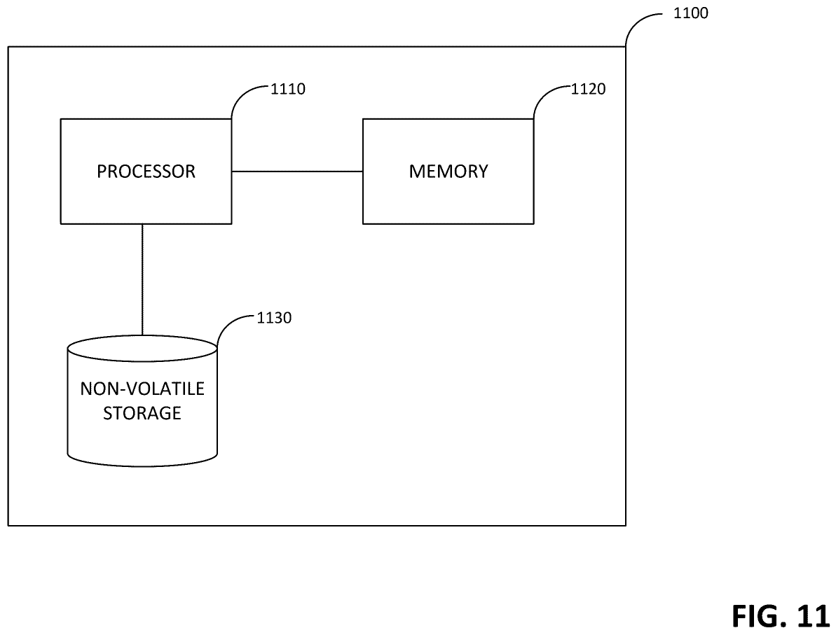

An illustrative implementation of a computer system 1100 that may be used to control a baseband pulse sequence controller, control a clock signal generator (e.g., to generate a common clock signal) to perform any of the techniques described above is shown in FIG. 11. The computer system 1100 may include one or more processors 1110 and one or more non-transitory computer-readable storage media (e.g., memory 1120 and one or more non-volatile storage media 1130). The one or more processors 1110 may control writing data to and reading data from the memory 1120 and the one or more non-volatile storage media 1130 in any suitable manner, as the aspects of the disclosure described herein are not limited in this respect. To perform functionality and/or techniques described herein, the one or more processors 1110 may execute one or more instructions stored in one or more computer-readable storage media (e.g., the memory 1120, storage media, etc.), which may serve as non-transitory computer-readable storage media storing instructions for execution by the one or more processors 1110.

In connection with techniques described herein, code used to, for example, generate baseband pulse sequences, generate digital values to instruct a digital logic to generate baseband pulse sequences, etc. may be stored on one or more computer-readable storage media of computer system 1100. The one or more processors 1110 may execute any such code to perform any of the above-described techniques as described herein. Any other software, programs or instructions described herein may also be stored and executed by computer system 1100. It will be appreciated that computer code may be applied to any aspects of methods and techniques described herein. For example, computer code may be applied to automatically calibrating parameters of a baseband pulse sequence, synchronizing operations with a common clock signal, etc.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as described above.

The terms “program,” “software,” and/or “application” are used herein in a generic sense to refer to any type of computer code or set of computer-executable instructions that can be employed to program a computer or other processor to implement various aspects of embodiments as described above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Having thus described several aspects of at least one embodiment of this disclosure, it is to be appreciated that various alterations, modifications, and improvements will readily occur to those skilled in the art. For instance, aspects of the techniques described herein may be combined in any of the following ways:
Aspect 1. A system comprising: a plurality of qubits including a first qubit and a second qubit; and at least one controller configured to: generate a common clock signal; apply a first baseband pulse sequence to the first qubit; and apply a second baseband pulse sequence to the second qubit; wherein the first baseband pulse sequence and the second baseband pulse sequence are temporally aligned according to the common clock signal.
Aspect 2. The system of aspect 1, wherein the first baseband pulse sequence and the second baseband pulse sequence begin at the same time, and wherein the first baseband pulse sequence and the second baseband pulse sequence end at the same time.
Aspect 3. The system of aspect 1, wherein the at least one controller is configured to generate the first baseband pulse sequence based on one or more gate parameters of a gate to be applied to the first qubit.
Aspect 4. The system of aspect 3, wherein the first baseband pulse sequence comprises a first pulse and a second pulse, and wherein the at least one controller is configured to select a time between the first pulse and the second pulse according to the one or more gate parameters.
Aspect 5. The system of aspect 1, wherein the first baseband pulse sequence comprises a first pulse and a second pulse, wherein the first pulse and second pulse have opposite amplitudes.
Aspect 6. The system of aspect 5, wherein the first pulse and the second pulse have equal and opposite amplitudes.
Aspect 7. The system of aspect 5, wherein the first baseband pulse sequence comprises a first idle period prior to the first pulse, a second idle period between the first pulse and the second pulse, and a third idle period subsequent to the second pulse.
Aspect 8. The system of aspect 7, wherein the at least one controller is configured to: generate the first baseband pulse sequence based on one or more gate parameters of a gate to be applied to the first qubit; and select a length of the second idle period according to the one or more gate parameters.
Aspect 9. The system of aspect 8, wherein the at least one controller is configured to select an amplitude of the first pulse and the second pulse according to the one or more gate parameters.
Aspect 10. The system of aspect 1, wherein the at least one controller is configured to generate the first baseband pulse sequence based on a plurality of primitive digital pulse sequences.
Aspect 11. The system of aspect 10, wherein the at least one controller is configured to generate a plurality of primitive analog pulse sequences by applying a respective amplitude to each of the plurality of primitive digital pulse sequences, and to combine the plurality of primitive analog pulse sequences to produce the first baseband pulse sequence.
Aspect 12. The system of aspect 1, wherein the first baseband pulse sequence is configured to apply a single qubit gate to the first qubit.
Aspect 13. The system of aspect 1, wherein the first baseband pulse sequence configured to apply an entangling gate to at least the first qubit.
Aspect 14. The system of aspect 1, wherein the first baseband pulse sequence configured to apply an identity gate to the first qubit.
Aspect 15. The system of aspect 1, wherein the first baseband pulse sequence configured to apply a Landau-Zener gate to the first qubit.
Aspect 16. The system of aspect 1, wherein the common clock signal has a frequency of between 10 MHz and 100 MHz.
Aspect 17. The system of aspect 1, wherein the first qubit and the second qubit are fluxonium qubits.
Aspect 18. The system of aspect 17, further comprising a waveguide inductively coupled to the first qubit, and wherein applying the first baseband pulse sequence to the first qubit comprises transmitting the first baseband pulse sequence through the waveguide.
Aspect 19. A method comprising: by at least one controller: generating a common clock signal; applying a first baseband pulse sequence to a first qubit; and applying a second baseband pulse sequence to a second qubit, wherein the first baseband pulse sequence and the second baseband pulse sequence are temporally aligned according to the common clock signal.
Aspect 20. The method of aspect 19, wherein the first baseband pulse sequence and the second baseband pulse sequence begin at the same time, and wherein the first baseband pulse sequence and the second baseband pulse sequence end at the same time.
Aspect 21. The method of aspect 19, further comprising generating the first baseband pulse sequence based on one or more gate parameters of a gate to be applied to the first qubit.
Aspect 22. The method of aspect 21, wherein the first baseband pulse sequence comprises a first pulse and a second pulse, and wherein the method further comprises selecting a time between the first pulse and the second pulse according to the one or more gate parameters.
Aspect 23. The method of aspect 19, wherein the first baseband pulse sequence comprises a first pulse and a second pulse, wherein the first pulse and second pulse have opposite amplitudes.
Aspect 24. The method of aspect 23, wherein the first pulse and the second pulse have equal and opposite amplitudes.
Aspect 25. The method of aspect 23, wherein the first baseband pulse sequence comprises a first idle period prior to the first pulse, a second idle period between the first pulse and the second pulse, and a third idle period subsequent to the second pulse.
Aspect 26. The method of aspect 25, further comprising: generating the first baseband pulse sequence based on one or more gate parameters of a gate to be applied to the first qubit; and selecting a length of the second idle period according to the one or more gate parameters.
Aspect 27. The method of aspect 26, further comprising selecting an amplitude of the first pulse and the second pulse according to the one or more gate parameters.
Aspect 28. The method of aspect 19, further comprising generating the first baseband pulse sequence based on a plurality of primitive digital pulse sequences.
Aspect 29. The method of aspect 28, further comprising generating a plurality of primitive analog pulse sequences by applying a respective amplitude to each of the plurality of primitive digital pulse sequences, and combining the plurality of primitive analog pulse sequences to produce the first baseband pulse sequence.
Aspect 30. The method of aspect 19, wherein the first baseband pulse sequence applies a single qubit gate to the first qubit.
Aspect 31. The method of aspect 19, wherein the first baseband pulse sequence applies an entangling gate to at least the first qubit.
Aspect 32. The method of aspect 19, wherein the first baseband pulse sequence applies an identity gate to the first qubit.
Aspect 33. The method of aspect 19, wherein the first baseband pulse sequence applies a Landau-Zener gate to the first qubit.
Aspect 34. The method of aspect 19, wherein the common clock signal has a frequency of between 10 MHz and 100 MHz.
Aspect 35. The method of aspect 19, wherein the first qubit and the second qubit are fluxonium qubits.
Aspect 36. The method of aspect 35, wherein applying the first baseband pulse sequence to the first qubit comprises transmitting the first baseband pulse sequence through a waveguide inductively coupled to the first qubit.

Such alterations, modifications, and improvements are intended to be part of this disclosure and are intended to be within the spirit and scope of the disclosure. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Aspects of the above-described embodiments of the technology described herein can be implemented in any of numerous ways. For example, aspects of the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, aspects of the disclosure may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system comprising:
a plurality of qubits including a first qubit and a second qubit; and
at least one controller configured to:
generate a common clock signal;
apply a first baseband pulse sequence to the first qubit; and
apply a second baseband pulse sequence to the second qubit;
wherein the first baseband pulse sequence and the second baseband pulse sequence are temporally aligned according to the common clock signal.

2. The system of claim 1, wherein the first baseband pulse sequence and the second baseband pulse sequence begin at the same time, and wherein the first baseband pulse sequence and the second baseband pulse sequence end at the same time.

3. The system of claim 1, wherein the at least one controller is configured to generate the first baseband pulse sequence based on one or more gate parameters of a gate to be applied to the first qubit.

4. The system of claim 3, wherein the first baseband pulse sequence comprises a first pulse and a second pulse, and wherein the at least one controller is configured to select a time between the first pulse and the second pulse according to the one or more gate parameters.

5. The system of claim 1, wherein the first baseband pulse sequence comprises a first pulse and a second pulse, wherein the first pulse and second pulse have opposite amplitudes.

6. The system of claim 5, wherein the first baseband pulse sequence comprises a first idle period prior to the first pulse, a second idle period between the first pulse and the second pulse, and a third idle period subsequent to the second pulse.

7. The system of claim 6, wherein the at least one controller is configured to:
generate the first baseband pulse sequence based on one or more gate parameters of a gate to be applied to the first qubit; and
select a length of the second idle period according to the one or more gate parameters.

8. The system of claim 7, wherein the at least one controller is configured to select an amplitude of the first pulse and the second pulse according to the one or more gate parameters.

9. The system of claim 1, wherein the at least one controller is configured to generate the first baseband pulse sequence based on a plurality of primitive digital pulse sequences.

10. The system of claim 9, wherein the at least one controller is configured to generate a plurality of primitive analog pulse sequences by applying a respective amplitude to each of the plurality of primitive digital pulse sequences, and to combine the plurality of primitive analog pulse sequences to produce the first baseband pulse sequence.

11. The system of claim 1, wherein the first qubit and the second qubit are fluxonium qubits.

12. The system of claim 11, further comprising a waveguide inductively coupled to the first qubit, and wherein applying the first baseband pulse sequence to the first qubit comprises transmitting the first baseband pulse sequence through the waveguide.

13. A method comprising:
by at least one controller:
generating a common clock signal;
applying a first baseband pulse sequence to a first qubit; and
applying a second baseband pulse sequence to a second qubit,
wherein the first baseband pulse sequence and the second baseband pulse sequence are temporally aligned according to the common clock signal.

14. The method of claim 13, wherein the first baseband pulse sequence and the second baseband pulse sequence begin at the same time, and wherein the first baseband pulse sequence and the second baseband pulse sequence end at the same time.

15. The method of claim 13, further comprising generating the first baseband pulse sequence based on one or more gate parameters of a gate to be applied to the first qubit.

16. The method of claim 15, wherein the first baseband pulse sequence comprises a first pulse and a second pulse, and wherein the method further comprises selecting a time between the first pulse and the second pulse according to the one or more gate parameters.

17. The method of claim 13, wherein the first baseband pulse sequence comprises a first pulse and a second pulse, wherein the first pulse and second pulse have opposite amplitudes.

18. The method of claim 17, wherein the first pulse and the second pulse have equal and opposite amplitudes.

19. The method of claim 17, wherein the first baseband pulse sequence comprises a first idle period prior to the first pulse, a second idle period between the first pulse and the second pulse, and a third idle period subsequent to the second pulse.

20. The method of claim 19, further comprising:
generating the first baseband pulse sequence based on one or more gate parameters of a gate to be applied to the first qubit; and
selecting a length of the second idle period according to the one or more gate parameters.

21. The method of claim 20, further comprising selecting an amplitude of the first pulse and the second pulse according to the one or more gate parameters.

22. The method of claim 13, further comprising generating the first baseband pulse sequence based on a plurality of primitive digital pulse sequences.

23. The method of claim 22, further comprising generating a plurality of primitive analog pulse sequences by applying a respective amplitude to each of the plurality of primitive digital pulse sequences, and combining the plurality of primitive analog pulse sequences to produce the first baseband pulse sequence.

24. The method of claim 13, wherein the first baseband pulse sequence applies a single qubit gate to the first qubit.

25. The method of claim 13, wherein the first baseband pulse sequence applies an identity gate to the first qubit.

26. The method of claim 13, wherein the first baseband pulse sequence applies a Landau-Zener gate to the first qubit.
